(19) United States
(12) Patent Application Publication
(10) Pub. No.: US 2017/0229882 A1
(43) Pub. Date: Aug. 10, 2017

(54) POWER DEVICE HAVING HIGH ELECTRICITY STORAGE PERFORMANCE CAPACITOR

(71) Applicant: KSFL CO., LTD., Taipei City (TW)

(72) Inventor: RONG-SAN LIN, Taipei City (TW)

(21) Appl. No.: 15/209,781

(22) Filed: Jul. 14, 2016

(30) Foreign Application Priority Data
Feb. 4, 2016 (TW) 105201819

(51) Int. Cl. H02J 7/00

(52) U.S. Cl. CPC H02J 7/0016; H02J 7/345

(57) ABSTRACT

A power device having high electricity storage performance capacitor is disclosed, which may include a least one high electricity storage performance capacitor, a balancing circuit and at least one Lithium battery. The balancing circuit may be electrically connected between the high electricity storage performance capacitor and the Lithium battery; the high electricity storage performance capacitor may include a capacitor substrate and a plurality of nanometer particles; the nanometer particles may irregularly stack over the surface of the capacitor substrate and there are gaps forming between the nanometer particles to obtain higher specific surface area; in this way, the high electricity storage performance capacitor can attract more negative and positive ions of the electrolytic solution to increase the electricity energy stored in the capacitor. Therefore, the balancing circuit can transmit the electricity energy in the high electricity storage performance capacitor to the Lithium battery to quickly charge the Lithium battery.

### BACKGROUND OF THE INVENTION

(a) Field of the Invention

The present invention generally relates to a power device having high electricity storage performance capacitor; more specifically, the present invention uses the electrospinning spraying method to spray the coating liquid over the surface of a capacitor substrate to make the coating liquid form a plurality of nanometer particles stacking over the surface of the capacitor substrate so as to obtain higher specific surface area; in this way, the capacitor can attract more negative and positive ions of the electrolytic solution to constitute a high electricity storage performance capacitor; further, a balancing circuit is connected between the high electricity storage performance capacitor and a Lithium battery; the balancing circuit can transmit the electricity energy stored in the high electricity storage performance capacitor to the Lithium battery in order to quickly charge the Lithium battery.

(b) Description of the Related Art

In general, the major manufacturing method of a conventional capacitor substrate is dip-sintering method, because the conventional dip-sintering method can obtain RuO2 in a short time without a large number of equipment and complicated manufacturing process; therefore, the dip-sintering method is comprehensively used; however, the RuO2 obtained by the conventional dip-sintering method has crystallinity, which is of anhydrous gypsum RuO2 structure; thus, the effect of the capacitor works on the gaps and cracks of the crystals; the crystal crack structure belongs to planar structure.

However, the issue which the conventional dip-sintering method needs to solve is insufficient specific surface area; therefore, the generated capacity effect can no longer satisfy the requirements of the actual applications; the reason why is that the crack structure of the RuO2 electrode crystals obtained by the conventional dip-sintering method belong to planar structure; thus, the capacitance will only exist in the cracks; as a result, the crystallization zone without cracks is useless; for the reason, the conventional dip-sintering method should increase the times of the dipping process so as to increase the capacitance; however, the increase of the times of the dipping processes will bring about the instability that the structure begins to collapse.

On the other hand, the conventional dip-sintering method cannot obviously increase the capacitance because the crystallization structure is very compact; the capacity effect of the capacitor of the Ru metal-oxide are from two sources; one is the effect of the electrical double layer; briefly speaking, the effect is that the positive one attracts the negative one with each other; the other one is semi-redox reaction (or pseudo-capacitance); Ru is one of the group of the transition metal elements, and the feature of the elements in this group is abundant external valence electrons; they not only tend to lose electrons, but also tend to receive electrons; after the capacitor is charged, Ru and the H ions in the electrolytic solution will generate temporary coordinate bonds for a short period; during the charging and discharging processes, a lot of charges are transmitted; as a result, most of the electric capacity of RuO2 is caused by the reaction phenomenon. The problem is that the aforementioned contact structure; the ions in the electrolytic solution of the low coating layer can deeply enter the cracks and function, but the ions in the electrolytic solution of the high coating layer can only function on the surface of the electron; regarding the deep layer, the ions in the electrolytic solution cannot deeply enter, which will make the electric capacity cannot effectively increase; during the charging process, as the positive electrode is at the high voltage pressure end, the ions are hard to enter the deep layer; thus, the bias status is formed, in particular to the positive end of the first layer; after a long period of time, the positive electrode will inflate; at this time, the capacitor is going to explode, which is a dangerous stage.

Therefore, how to effectively increase the electricity storage performance of the capacitor and use the capacitor to quickly charge the Lithium battery are the issues which the present invention want to solve.

### SUMMARY OF THE INVENTION

Therefore, it is a primary objective of the present invention to provide a detachable movable device and an electronic device thereof to achieve the effect of reducing the tear and wear of a touch display panel of a general electronic device.

The present invention provides a power device having high electricity storage performance capacitor, which may include a least one high electricity storage performance capacitor, a balancing circuit and at least one Lithium battery. The balancing circuit may be electrically connected between the high electricity storage performance capacitor and the Lithium battery; the high electricity storage performance capacitor may include a capacitor substrate and a plurality of nanometer particles; the nanometer particles may irregularly stack over the surface of the capacitor substrate and there are gaps forming between the nanometer particles; the nanometer particles can be formed by spraying a coating liquid over the surface of the capacitor substrate by the electrospinning spraying method. The higher specific surface area can be obtained by a plurality of nanometer particles stacking over the surface of the capacitor substrate and a plurality of gaps thereof so as to make the high electricity storage performance capacitor attract more positive and negative ions of the electrolytic solution and increase the electricity energy stored in the capacitor. In this way, the balancing circuit can transmit the electricity energy stored in the high electricity storage performance capacitor to the Lithium battery in order to quickly charge the Lithium battery.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the structure diagram of the power device in accordance with the present invention.

FIG. 2 is the partial enlargement diagram of the structure of the power device having high electricity storage performance capacitor in accordance with the present invention.

### DETAILED DESCRIPTION OF THE PREFERRED EMBODIMENTS

The technical content of the present invention will become apparent by the detailed description of the following embodiments and the illustration of related drawings as follows.

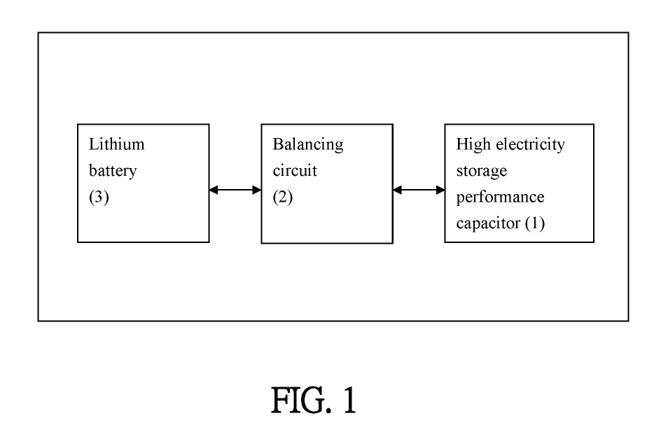

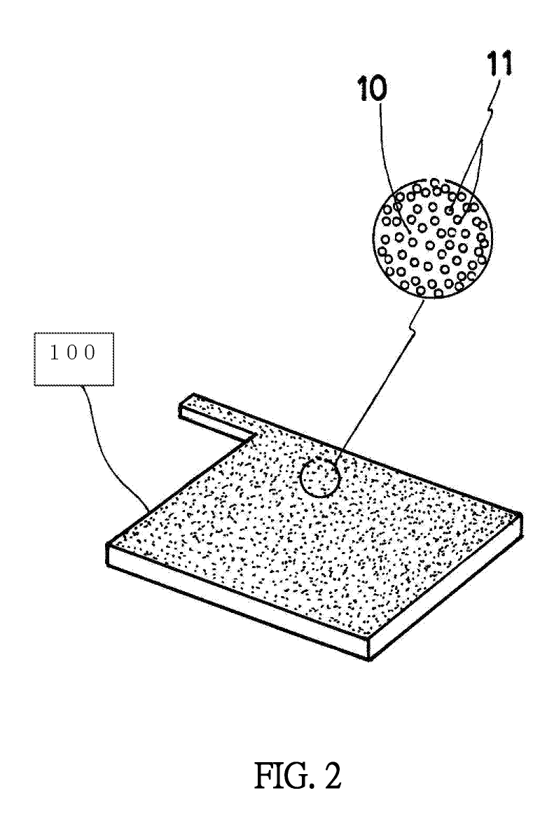

Please refer to FIG. 1 and FIG. 2; the present invention discloses a power device having high electricity storage performance capacitor, including at least one high electricity storage performance capacitor 1, a balancing circuit 2 and at least one Li battery.

The high electricity storage performance capacitor 1 includes at least one capacitor substrate 100 and a plurality of nanometer particles 11. The material of the capacitor substrate 100 may be Ti. The nanometer particles 11 irregularly stack over the surface of the capacitor substrate 100; there are gaps forming between the nanometer particles 11; the nanometer particles 11 are formed by the electrospinning spraying method to spray a predetermined coating liquid over the surface of the capacitor substrate 100; in this way, the coating liquid can form a plurality of nanometer particles 11 stacking over the surface of the capacitor substrate 100. The coating liquid may be RuO2, RuO2 mixed with grapheme or RuO2 mixed with conductive polymer.

The balancing circuit 2 has an input end and an output end.

The balancing circuit 2 is electrically connected between the high electricity storage performance capacitor 1 and the Lithium battery 3; the input end of the balancing circuit 2 is electrically connected to the high electricity storage performance capacitor 1, and the output end of the balancing circuit 2 is electrically connected to the Lithium battery 3; in this way, the electricity energy stored in the high electricity storage performance capacitor 1 can be transmitted to the Lithium battery 3 via the balancing circuit 2.

It is worthy to note that the electrospinning spraying method is to put a predetermined coating liquid in an electrospinning equipment; then, the electrospinning equipment can use high voltage electricity to generate voltage difference so as to manufacture nanometer substances; by means of the electrospinning spraying method, the coating liquid can be sprayed to stack over the surface of the capacitor substrate 100 by the form of the nanometer particles 11 in order to form gaps between the nanometer particles 11. As the surface of the capacitor substrate 100 has the nanometer particles 11 and gaps 10, the capacitor substrate 100 can have higher specific surface area. Accordingly, during the capacitor back-end manufacturing process of the capacitor substrate 100, the capacitor substrate 100 can attract more positive and negative ions in the electrolytic solution because of the nanometer particles 11 and the gaps 10 formed over the surface of the capacitor substrate 100 for the purpose of increasing the increase the electricity energy stored in the high electricity storage performance capacitor 1.

The capacitor substrate can forms two or more than two stacks to constitute the high electricity storage performance capacitor 1, and the high electricity storage performance capacitor 1 can have the positive and the negative electrodes as the conductive junctions. The capacitor substrate 100 may have any shape, such that when two or more than two capacitor substrates 1 can stack to form a high electricity storage performance capacitor 1 with any shape. For example, the capacitor can be manufactured to be shaped like a phone.

The technical feature of the present invention is to stack a plurality of nanometer particles 11 over the surface of the capacitor substrate 100 and form a plurality of gaps 10 so as to obtain higher specific surface area; in this way, the high electricity storage performance capacitor 1 can attract more positive and negative ions in the electrolytic solution so as to increase the electricity energy stored in the high electricity storage performance capacitor 1; in addition, by means of the balancing circuit 2 electrically connected to the high electricity storage performance capacitor 1 and the Lithium battery 3, the balancing circuit 2 can transmit the electricity energy stored in the high electricity storage performance capacitor 1 to the Lithium battery 3 in order to quickly charge the Lithium battery 3.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

I claim:

1. A power device having high electricity storage performance capacitor, comprising:
at least one high electricity storage performance capacitor;
at least one capacitor substrate;
a plurality of nanometer particles, stacking on a surface of the capacitor substrate by an electrospinning spraying method, wherein there are gaps forming between the nanometer particles;
a balancing circuit; and
at least one Lithium battery;
Wherein the balancing circuit is connected between the high electricity storage performance capacitor and the Lithium battery, and the balancing circuit transmits an electricity energy stored in the high electricity storage performance capacitor to the Lithium battery so as to charge the Lithium battery.

2. The power device having high electricity storage performance capacitor of claim 1, wherein a material of the capacitor substrate is Ti.

3. The power device having high electricity storage performance capacitor of claim 1, wherein the nanometer particles are formed by spraying a predetermined coating liquid over the surface of the capacitor substrate by the electrospinning spraying method; the coating liquid is able to form the nanometer particles stacking over the surface of the capacitor substrate.

4. The power device having high electricity storage performance capacitor of claim 3, wherein a material of the coating liquid is a RuO2.

5. The power device having high electricity storage performance capacitor of claim 3, wherein a material of the coating liquid is a RuO2 mixed with a graphene.

6. The power device having high electricity storage performance capacitor of claim 3, wherein a material of the coating liquid is a RuO2 mixed with a conductive polymer.

7. The power device having high electricity storage performance capacitor of claim 1, wherein the capacitor substrate forms two or more than two stacks to constitute the high electricity storage performance capacitor.

8. The power device having high electricity storage performance capacitor of claim 7, wherein the high electricity storage performance capacitor is able to have any shape.
